(19) United States
(12) Patent Application Publication
(10) Pub. No.: US 2006/0169624 A1
(43) Pub. Date: Aug. 3, 2006

(54) Cleaning system containing a solvent filtration device and method for using the same

(76) Inventors: Arseni Valerevich Radomyselski, Hamilton, OH (US); Paul Amaat Raymond Gerard France, West Chester, OH (US); Scott Edward Powell, Loveland, OH (US); Dewey Edward Burton, Fairfield, OH (US); William Michael Scheper, Lawrenceburg, IN (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/368,843

(22) Filed: Mar. 6, 2006

Related U.S. Application Data
(63) Continuation of application No. 10/426,171, filed on Apr. 29, 2003, now abandoned.
(63) Continuation-in-part of application No. 10/237,452, filed on Sep. 9, 2002.
(63) Continuation-in-part of application No. 10/238,009, filed on Sep. 9, 2002.
(60) Provisional application No. 60/377,140, filed on May 2, 2002.
(60) Provisional application No. 60/400,274, filed on Jul. 31, 2002.
(60) Provisional application No. 60/318,394, filed on Sep. 10, 2001.
(60) Provisional application No. 60/318,440, filed on Sep. 10, 2001.

(51) Int. Cl. B01D 17/12

(52) U.S. Cl. 210/96.1; 134/110; 210/167; 210/263; 210/266; 210/502.1

(57) ABSTRACT

A cleaning system comprising a reservoir of cleaning solvent, a fabric article treating vessel and a filtration device for removing contaminants from the cleaning solvent. The filtration device comprises an absorbent material having a water absorbing capacity of at least about 50 g of water/g of absorbent material and an adsorbent material having an adsorbent capacity at least about 200 mg contaminants per gram of adsorbent material. A method for using the same is also disclosed.

### CROSS REFERENCE TO RELATED APPLICATIONS

This application is a continuation of co-pending U.S. patent application Ser. No. 10/426,171, filed on Apr. 29, 2003, which claims priority under 35 U.S.C. §119(e) from Provisional Application Ser. No. 60/377,140, filed on May 2, 2002, and Provisional Application Serial No. 60/400,274, filed on Jul. 31, 2002; and is a continuation-in-part of co-pending U.S. patent application Ser. No. 10/237,452, filed on Sep. 9, 2002, which claims priority under 35 U.S.C. § 119(e) from Provisional Application Ser. No. 60/318,394, filed on Sep. 10, 2001; and is a continuation-in-part of co-pending U.S. patent application Ser. No. 10/238,009, filed on Sep. 9, 2002, which claims priority under 35 U.S.C. §119(e) from Provisional Application Ser. No. 60/318,440, filed on Sep. 10, 2001.

### FIELD OF THE INVENTION

The present invention relates to a cleaning system comprising a source of cleaning solvent, a fabric article treating vessel and a filtration device for removing contaminants from a used cleaning solvent. A method for using the system, especially the filtration device, to remove contaminants from a cleaning solvent is also disclosed.

### BACKGROUND OF THE INVENTION

Conventional laundering techniques for cleaning and refreshing (e.g., removing malodors) fabric articles can be generally categorized into the aqueous-based washing technique and the “dry cleaning” technique. The former involves immersion of the fabric article in a solution comprising primarily of water; detergent or soap may be added to enhance the cleaning function. The latter typically involves the use of non-aqueous fluids as the agent for cleaning and refreshing.

Cleaning solvents, after being used in a laundering treatment, typically comprise contaminants, such as dyes, water and/or surfactants. Since the cleaning solvents are more expensive than water, there is a need to recycle/reuse the cleaning solvents in more than one treatment. Conventional cleaning solvents are subjected to a distillation method to remove some contaminants. However, equipment and conditions to run a distillation method are extremely burdensome. Accordingly, there is a need to remove contaminants from cleaning solvents without distillation. Representative systems using the distillation method are disclosed in EP 543,665 and U.S. Pat. Nos. 5,942,007; 6,056,789; 6,059,845; and 6,086,635.

One attempt at such method is evident by the use of a commercially available KleenRite® filter. The KleenRite® filter is made of a clay absorbent and an activated carbon adsorbent. Representative filters containing carbon and clay adsorbent materials are disclosed in U.S. Pat. Nos. 4,277,336 and 3,658,459. However, such filter has a rather limited lifetime due to the high percentage of clay absorbent in the filter. The clay absorbent has a finite capacity for absorbing contaminants, such as water, and once that capacity is met, the filter must be replaced with a new filter. In addition to the limitations around the clay absorbent, the activated carbon adsorbent has limitations also. The particle size and/or pore size of the activated carbon adsorbent material allows some contaminants to flow past the activated carbon adsorbent material, thus making the filter ineffective. Further, in conventional use, the used, contaminated cleaning solvent is pumped through the filter at a rate that does not allow the clay absorbent and/or activated carbon adsorbent to remove contaminants effectively.

Therefore, there is a need for a cleaning system for cleaning a fabric article and removing contaminants from a cleaning solvent such that the filtered solvent can be recycled/reused; filters that more effectively removes contaminant from a cleaning solvent and have a longer lifetime than conventional filters; and a method that cleans a fabric article and effectively removes contaminants from a cleaning solvent.

### SUMMARY OF THE INVENTION

The present invention relates to a system for non-aqueous cleaning of a fabric article and removal of contaminants from the cleaning solvent comprising:
(a) a reservoir of a working solvent;
(b) a fabric article treating vessel operatively connected to the reservoir, wherein the working solvent comes into contact with a fabric article in the vessel and removes contaminants from the fabric article, thereby converting the working solvent into a used solvent; and
(c) a filtration device for removing contaminants from the used solvent, wherein the filtration device is operatively connected to the reservoir and/or the vessel and comes into contact with the used solvent during the operation of the system;
   wherein the filtration device comprises an absorbent material having a water absorbing capacity of at least about 50 g of water/g of absorbent material and an adsorbent material having an Adsorbent Capacity at least about 200 mg contaminants per gram of adsorbent material.

Another aspect of the present invention relates to a method of using the above system to clean a fabric article and to remove contaminants from the used solvent.

### BRIEF DESCRIPTION OF THE DRAWINGS

FIG. 1 is a schematic representation of a cleaning system in accordance with one embodiment of the present invention;

FIG. 2 is a schematic representation of a cleaning system in accordance with another embodiment of the present invention; and

FIG. 3 is a schematic representation of an emulsion de-watering filter suitable for use in the cleaning systems of the present invention.

### DETAILED DESCRIPTION

### DEFINITIONS

The term “fabric article” as used herein means any article that is customarily cleaned in a conventional laundry process or in a cleaning process. As such the term encompasses articles of clothing, linen, drapery, and clothing accessories. The term also encompasses other items made in whole or in part of fabric, such as tote bags, furniture covers, tarpaulins and the like.

The term “absorbent material” or “absorbent polymer” as used herein means any material capable of selectively ingesting (i.e., absorbing or adsorbing) water and/or water-containing liquids without ingesting cleaning solvents. In other words, absorbent materials or absorbent polymers comprise a water absorbing agent, which is referred to in the art as “gel”, “polymeric gel” and “super absorbent polymers”.

The term “absorbent matrix” as used herein means a matrix in any form that is capable of absorbing water. The absorbent matrix comprises an absorbent material, and optionally, a spacer material and/or a high surface area material.

The term “cleaning solvent” as used herein means any non-aqueous fluid capable of removing sebum. Cleaning solvents include lipophilic solvents, which are described in more details herein below. The cleaning solvent encompasses the “working solvent”, the “used solvent” or the “filtered solvent”, which are the different forms taken on by the cleaning solvent as it passes through the present system or method during a cleaning and filtration operation.

The term “cleaning composition” as used herein means any cleaning solvent-containing composition that comes into direct contact with fabric articles to be cleaned. It should be understood that the composition can have uses other than cleaning, such as conditioning, sizing, and other fabric care treatments. Thus, it may be used interchangeably with the term “treating composition”. Furthermore, optional cleaning adjuncts such as additional detersive surfactants, bleaches, perfumes, and the like may be added to the “cleaning composition”. That is, cleaning adjuncts may be optionally combined with the cleaning solvent. These optional cleaning adjuncts are described in more detail herein below.

The term “dry cleaning” or “non-aqueous cleaning” as used herein means a non-aqueous fluid is used as the cleaning solvent to clean a fabric article. However, water can be added to the “dry cleaning” method as an adjunct cleaning agent. The amount of water can comprise up to about 25% by weight of the cleaning solvent or the cleaning composition in a “dry cleaning” process.

The term “soil” as used herein means any undesirable extraneous substance on a fabric article that is the target for removal by a cleaning process. By the terms “water-based” or “hydrophilic” soils, it is meant that the soil comprised water at the time it first came in contact with the fabric article, or the soil retains a certain amount of water on the fabric article. Examples of water-based soils include, but are not limited to beverages, many food soils, water soluble dyes, bodily fluids such as sweat, urine or blood, outdoor soils such as grass stains and mud.

As used herein, the term “insoluble” means that a material will physically separate (i.e. settle-out, flocculate, float) from the liquid medium (a cleaning solvent or water) within 5 minutes after being added to the liquid medium, whereas the term “soluble” means that a material does not physically separate from the liquid medium within 5 minutes after addition.

Components of The Cleaning System

a. Cleaning Solvent

The cleaning system comprises a reservoir for providing a cleaning solvent. Cleaning solvents generally known for their use in a dry cleaning process are suitable for use in the present invention. Nonlimiting examples of such cleaning solvents include PERC, hydrocarbons, silicone-containing solvents and glycol, ether solvents.

The cleaning solvent may be a lipophilic fluid. In general, a suitable lipophilic fluid can be fully liquid at ambient temperature and pressure, can be a low melting solid having a melting temperature in the range from about 0° C. to about 60° C., or can be a mixture of liquids and their vapor phases at ambient temperatures and pressures (i.e., 25° C. and 1 atmospheric pressure). Thus, the lipophilic fluid suitable for use herein is not a compressible gas, such as carbon dioxide. It is preferred that the lipophilic fluid herein be inflammable, have relatively high flash points, and/or low volatile organic compound (VOC) characteristics, at least equal to, and preferably exceed the characteristics of known conventional cleaning fluids. The terms “flash point” and “VOC”, as used herein, have their conventional meanings in the dry cleaning industry. Moreover, suitable lipophilic fluids are readily flowable and nonviscous. The lipophilic fluids should be capable of at least partially dissolving sebum or body soil, as defined in the Lipophilic Fluid Test below. Mixtures of lipophilic fluid are also suitable for use herein, provided that the requirements of the Lipophilic Fluid Test are met.

Lipophilic Fluid Test (LF Test) for The Qualification of Lipophilic Fluid

Any non-aqueous fluid that is both capable of meeting known requirements for a dry-cleaning fluid (e.g, flash point etc.) and is capable of at least partially dissolving sebum, as indicated by the test method described below, is suitable for use herein as a lipophilic fluid. As a general guideline, perfluorobutylamine (Fluorinert® FC-43) on its own (with or without adjuncts) is a reference material and is unsuitable as the lipophilic fluid herein (i.e., it is considered as essentially a non-solvent).

The following is the method for investigating and qualifying other materials, e.g., other low-viscosity, free-flowing silicones, for use as the lipophilic fluid. The method uses commercially available Crisco® canola oil, oleic acid (95% pure, available from Sigma Aldrich Co.) and squalene (99% pure, available from J. T. Baker) as model soils for sebum. The test materials should be substantially anhydrous and free from any added adjuncts, or other materials during evaluation.

Prepare three vials. Place 1.0 g of canola oil in the first; place 1.0 g of the oleic acid (95%) in a second vial, and place 1.0 g of the squalene (99%) in a third and final vial. To each vial, add 1 g of the fluid to be tested for lipophilicity. Separately mix, at room temperature and pressure, each vial for 20 seconds on a standard vortex mixer at maximum setting. Place vials on the bench and allow them to settle for 15 minutes at room temperature and pressure. If, upon standing, a single phase is formed in any of the vials, then the fluid qualifies as a “lipophilic fluid”. However, if two or more separate layers are formed in all three vials, then the amount of fluid dissolved in the oil phase will need to be measured before determining if the fluid qualifies as a “lipophilic fluid”.

In such a case, carefully extract a 200 microliter sample from each layer in each vial with a syringe. The extracted layer samples are placed in GC autosampler vials and subjected to conventional GC analysis. The GC instrument is calibrated with each of the three models soils and the fluid being tested. If any of the extracted layer samples contains more than 1% of any of the model soils, then the test fluid is qualified as a lipophilic fluid. If needed, the method can be further calibrated using heptacosafluorotributylamine (i.e., Fluorinert® FC-43) in preparing the vials with model soils. Extracted samples containing less model soils than the extracted Fluorinert® sample are disqualified as lipophilic fluids.

A suitable GC is a Hewlett Packard Gas Chromatograph HP5890 Series II equipped with a split/splitless injector and FID. A suitable column used in determining the amount of lipophilic fluid present is capillary column DB-1HT, 30 meters long, 0.25 mm id, 0.1 micron film thickness (catalog. no. 1221131, available from J&W Scientific). The GC is operated under the following conditions:
Carrier Gas: Hydrogen
Column Head Pressure: 9 psi (6.2×10⁴ N/m²)
Flows: Column flow rate of about 1.5 ml/min.
   Split vent flow rate of about 250-500 ml/min.
   Septum purge rate of 1 ml/min.
Injection: HP 7673 Autosampler, 10 microliters syringe, 1 microliter injection
Injector Temperature: 350° C.
Detector Temperature: 380° C.
Oven Temperature Program:
   initial temperature is 60° C.; hold for 1 minute; heat at a rate of 25° C./min to reach a final temperature of 380° C.; and hold for 30 minutes.

Suitable lipophilic fluids should also have an acceptable garment care profile. Garment care profile testing is well known in the art and involves contacting a test fluid with a wide range of garment or fabric article components, including fabrics, threads, elastics, seam materials, etc., and various button materials. Preferred lipophilic fluids have an excellent garment care profile, relating to care/durability of garment components (e.g., no appreciable damage to buttons and fasteners), and low shrinkage or fabric puckering profile, as well as an excellent safety profile (e.g., low flammability).

Due to the above garment care considerations, a fluid that satisfies the Lipophilic Fluid Test may nevertheless be provided in a mixture (e.g., with water); and the mixture is used as the lipophilic fluid for treating fabric articles. An example of such fluid is ethyl acetate. Ethyl acetate is effective in removing sebum, thus, qualifies as a lipophilic fluids, based on the Lipophilic Fluid Test. However, it can be quite objectionable in its tendency to dissolve buttons. Thus, it will preferably be formulated with water and/or other solvents so that the overall mixture does not substantially damage the buttons. Other lipophilic fluids, for example, cyclopentasiloxane (D5), meet the garment care requirements commendably without being blended with water and/or other solvents. Some suitable lipophilic fluids may be found in granted U.S. Pat. Nos. 5,865,852; 5,942,007; 6,042,617; 6,042,618; 6,056,789; 6,059,845; and 6,063,135.

Additionally, suitable lipophilic fluids may have an ozone reactivity of from about 0 to about 0.31; or a vapor pressure of from about 0 to about 0.1 mm Hg; or a vapor pressure of greater than 0.1 mm Hg, but have an ozone formation potential of from about 0 to about 0.31. The “ozone reactivity” or “maximum incremental reactivity (MIR)” is a measure of a VOC's ability to form ozone in the atmosphere and is expressed as grams of ozone formed per gram of VOC (i.e., a unitless index). A methodology to determine ozone reactivity was developed by Dr. William P. L. Carter of University of California, Riverside. Details of the methodology can be found in “Development of Ozone Reactivity Scales of Volatile Organic Compounds”, Journal of the Air & Waste Management Association, Vol. 44, Page 881-899, 1994, by W. P. L. Carter. The “vapor pressure” is measured by techniques defined in Method 310 of the California Air Resources Board. Nonlimiting examples of such lipophilic fluids include carbonate solvents (i.e., methyl carbonates, ethyl carbonates, ethylene carbonates, propylene carbonates, glycerine carbonates) and/or succinate solvents (i.e., dimethyl succinates).

A cleaning solvent suitable for use herein can be a composition, a portion of which can be fluorinated solvents, or perfluorinated amines. Some perfluorinated amines, such as perfluorotributylamines, are unsuitable for use as lipophilic fluids, may be present as one of many possible adjunct ingredients present in a lipophilic fluid-containing composition. Exemplary lipophilic fluids include, but are not limited to, diol solvent systems e.g., C6- or C8- or higher diols; linear and cyclic organosilicone solvents, and the like; and mixtures thereof. In some embodiments, suitable nonaqueous lipophilic fluids are used as a major component (i.e., greater than 50 wt % of the composition) of the cleaning compositions herein include low-volatility nonfluorinated organics, such as polyol polyesters, silicones, especially those silicones free of amino functionality, glycol ethers, and mixtures thereof. Low volatility nonfluorinated organics suitable for use in the cleaning compositions herein include, but are not limited to, OLEAN® and other polyol esters, and certain relatively nonvolatile biodegradable mid-chain branched petroleum fractions. Other suitable nonaqueous lipophilic fluids are glycol ethers, for example, propylene glycol methyl ether, propylene glycol n-propyl ether, propylene glycol t-butyl ether, propylene glycol n-butyl ether, dipropylene glycol methyl ether, dipropylene glycol n-propyl ether, dipropylene glycol t-butyl ether, dipropylene glycol n-butyl ether, tripropylene glycol methyl ether, tripropylene glycol n-propyl ether, tripropylene glycol t-butyl ether, tripropylene glycol n-butyl ether.

Lipophilic solvents can include linear and cyclic polysiloxanes, hydrocarbons and chlorinated hydrocarbons. More preferred are the linear and cyclic polysiloxanes and hydrocarbons of the glycol ether, acetate ester, and lactate ester families. Preferred lipophilic solvents include cyclic siloxanes having a boiling point (at 760 mm Hg) below about 250° C. Specifically preferred cyclic siloxanes for use in this invention are octamethylcyclotetrasiloxane, decamethylcyclopentasiloxane, and dodecamethylcyclohexasiloxane. It should be understood that useful cyclic siloxane mixtures might contain, in addition to the preferred cyclic siloxanes, minor amounts of other cyclic siloxanes, including hexamethylcyclo-trisiloxane or higher cyclics such as tetradecamethylcycloheptasiloxane. Generally, the amount of these other cyclic siloxanes in useful cyclic siloxane mixtures will be less than about 10 percent based on the total weight of the mixture. In one embodiment, silicones are used as the major component (i.e., more than about 50%) of the composition; specifically, the silicones include cyclopentasiloxanes, sometimes termed “D5”, and/or linear analogs having approximately similar volatility. Optionally, other compatible silicones are also included. Suitable silicones are well known in the literature, see, for example, Kirk-Othmer's Encyclopedia of Chemical Technology, and are available from a number of commercial sources, including General Electric, Toshiba Silicone, Bayer, and Dow Corning. Other suitable lipophilic fluids are commercially available from Procter & Gamble or from Dow Chemical and other suppliers. For example, one suitable silicone is SF-1528 available from GE silicone fluids. It is worth noting that SF-1528 fluid is 90% cyclopentasiloxane.

The cleaning solvent may be in any form and contained in any suitable container so long as it is associated with a cleaning system in a manner such that the cleaning solvent can come into contact with a fabric article being treated in the cleaning system. Such container of cleaning solvent is referred to as the “reservoir of cleaning solvent” in the cleaning system. Nonlimiting examples of suitable containers or reservoirs for cleaning solvents can be found in commercial cleaning machines.

b. Fabric Article Treating Vessel

The cleaning system comprises a fabric article treating vessel. Any suitable fabric article treating vessel known to those of ordinary skill in the art can be used. The fabric article treating vessel receives and retains a fabric article to be treated during the operation of the cleaning system. In other words, the fabric article treating vessel retains the fabric article while the fabric article is being contacted by the cleaning solvent. Nonlimiting examples of suitable fabric article treating vessels include commercial cleaning machines, domestic, in-home, washing machines, and clothes drying machines.

c. Filtration Device

During fabric treating processes, the cleaning solvents typically become contaminated with contaminants such as surfactants, water, dyes, soils and/or other “non-cleaning solvent materials”. Therefore, the cleaning system of the present invention also comprises a filtration device, which is capable of removing contaminants from a used solvent.

A filtration device suitable for use herein will remove sufficient contaminants from the cleaning solvent such that the level of contaminants in the filtered cleaning solvent does not impair its performance when it is used as the working cleaning solvent in subsequent fabric treating processes. The removal of contaminants from a cleaning solvent can be 100% removal of contaminants, but it does not have to be. Removal of about 50% to about 100% removal of contaminants present in the cleaning solvent can be sufficient. The type of fabric articles, type of contaminant are factors that influence the level of contaminants that may remain in the filtered cleaning solvent without impairing its cleaning performance. That is, the filtered cleaning solvent may comprise a higher level of one type of contaminant than another. For example, the level of dyes present in the filtered cleaning solvent may be from about 0.0001% to about 0.1%, preferably from about 0.00001% to about 0.1%, and more preferably from about 0% to about 0.01% by weight of the cleaning solvent. On the other hand, the level of water in the filtered cleaning solvent may be from about 0.001% to about 20%, preferably from about 0.0001% to about 5 % and more preferably from about 0% to about 1%.

The filtration device can remove contaminants from a used cleaning solvent by contacting it with the filtration device, thereby removing the contaminants from the used cleaning solvent and converting it into a filtered cleaning solvent. The filtered cleaning solvent, being substantially free of contaminants, can be recycled/reused immediately in another fabric treating cycle as the working cleaning solvent, but it does not have to be. In other words, the filtered cleaning solvent can be removed from the cleaning system, stored and used later as the working cleaning solvent in another system or another fabric cleaning cycle.

In one embodiment, the filtration device may contain adsorbent materials, absorbent materials, or mixtures thereof, in a single housing (e.g., a cartridge, a disc or a column) or separate, discrete housings. These materials are typically housed in discrete compartments within each housing; however, they may also be mixed and housed in a single compartment within each housing. The housings contain an inlet and an outlet arranged in such a way that the cleaning solvent circulates through the housing and comes into contact with the adsorbent and/or absorbent materials in the housing.

In another embodiment, the filtration device may comprise a liquid permeable pouch, bag, sachet, or like container. Such a filtration device can be dropped into the treating vessel or the solvent reservoir such that it in direct contact with, and may be physically surrounded by, the cleaning solvent. In a further embodiment, the filtration device may comprise pouches, bags, sachets or like containers that dissolve in the cleaning solvents.

The filtration device (including a housing, a pouch, a bag, a sachet or like container) can have any shape or size. At the minimum, it should hold sufficient adsorbent/absorbent materials to render the cleaning solvent substantially free of contaminants for an overnight (about 12 hours) filtration operation.

In yet another embodiment, the filtration device may comprise adsorbent/absorbent materials embedded in or coated on or bound to a fibrous structure, such as a nonwoven or woven fibrous web. The loading level of the adsorbent material in the nonwoven web ranges from about 10 to about 500 grams per square meter (gsm), preferably from about 25 to about 400 gsm and more preferably from about 50 to about 300 gsm. The thickness of the nonwoven web is generally in the range of from about 0.01 to about 10 mm, preferably from about 0.1 to about 5 mm. The non-woven web is desired to have a basis weight in the range of from about 5 to about 1000 gsm, preferably from about 10 to about 300 gsm. The filtration device may be formed into sheets, films, membranes or other configurations. The sheet configuration includes well-known variations, such as tubes, hollow fibers, spiral wound modules and flat sheets in plate and frame units.

In a further embodiment, the filtration device may comprise particulates of adsorbent materials that are dropped into the treating vessel or the solvent reservoir directly and mixed with the cleaning solvent by agitation, tumbling, or other known mixing techniques. The mixture of the adsorbent material and the cleaning solvent form a suspension or a slurry with a weight ratio of adsorbent material to cleaning solvent about 0.001:1 to 0.1:1. This approach makes a particular effective use of the adsorbent materials because it provides maximum contacts between the cleaning solvent and the particulates. An optional sieve filter may be added to the cleaning system to remove the particulate adsorbent materials from the cleaning solvent.

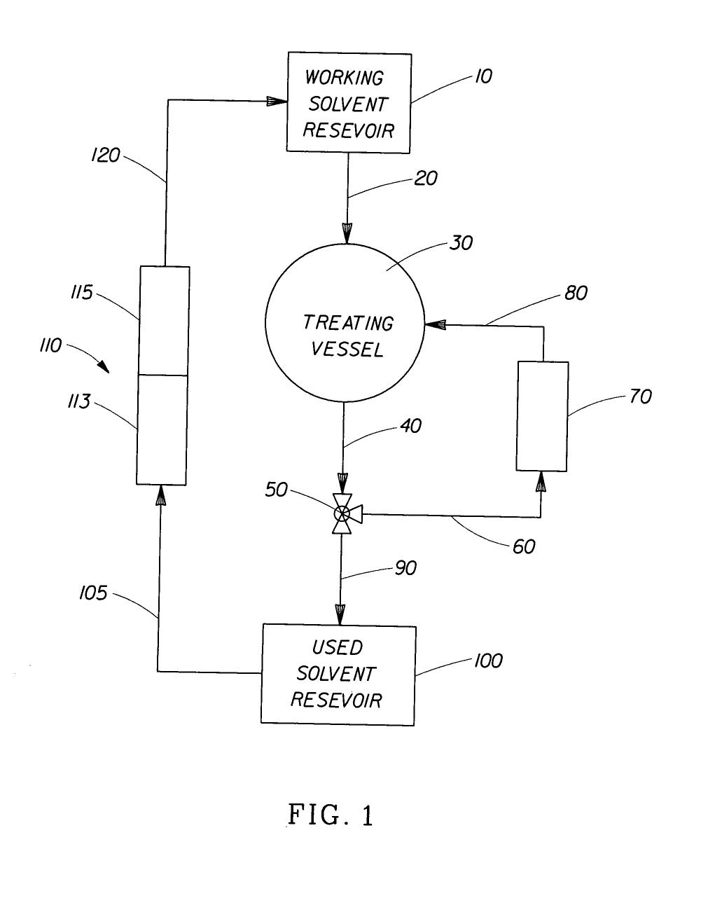

Removal of contaminants (i.e., types of contaminants and/or levels of contaminants) from a used cleaning solvent can be influenced by the residence time of the used cleaning solvent within the filtration device. For example, the residence time needed to remove dyes from a used cleaning solvent is shorter than the residence time needed to remove surfactants from the same used cleaning solvent. Further, the used cleaning solvent may be circulated through a multiplicity of filtration devices disclosed above, thus, the contaminants can be substantially removed by repeated exposure to various materials in the filtration devices. For example (see FIG. 1), the in-wash prefilter 70 may contain materials that effectively remove only dyes from the cleaning solvent being used in the treating vessel, whereas other contaminants may be effectively removed by passing the used cleaning solvent through dual filter 110, containing one or more adsorbent/absorbent materials, subsequent to the fabric article treating operation.

The residence time in the in-wash prefilter 70 may be quite short, typically ranging from about 0.1 to about 15 seconds, and more typically from about 0.5 to about 5 seconds. Thus, in one embodiment, prefilter 70 contains sufficient amount of adsorbent materials to substantially remove the contaminants (primarily dyes) within the above residence time. On the other hand, dual filter 110 may be used subsequent to the cleaning operation, consequently, the residence time therein may range from about 15 seconds to about 24 hours. For practical purposes, the residence time to substantially remove all contaminants should be less than about 12 hours (i.e., overnight filtration) so that the cleaning solvent is ready to be reused the next day.

Adsorbent Materials

Adsorbent materials useful in the filtration device of the present invention comprise a particulate material typically having an Adsorbent Capacity (as measured by the Adsorbent Capacity Test described below) of at least about 200 mg contaminants per gram of adsorbent, preferably at least about 300 mg contaminants per gram of adsorbent, and more preferably at least about 400 mg contaminants per gram of adsorbent.

Adsorption Capacity Test

The test is conducted at room temperature and pressure. A vial containing a mixture of 100 grams of a lipophilic liquid and 0.1 grams of an artificial body soil (available from Empirical Manufacturing Company Inc., Cincinnati, Ohio) and 0.1 grams of Neodol 91-2.5 surfactant (available from Shell Chemical Co., Houston, Tex.) is prepared; both the artificial body soil and the surfactant are considered contaminants for the purpose of this test. About 0.25 grams of a particulate adsorbent material is added to the vial; the exact weight of the adsorbent material is recorded. In the instant example, the adsorbent material is activated carbons ground into fine powder (with particle size of about 0.1 to about 300 microns). The vial containing the mixture and the adsorbent material is mixed thoroughly using 2 cm magnetic bar on mixer at 400 rpm setting for 24 hours. Place the vial on the bench and allow the mixture to settle for 8 hours. Then, extract 2 microliters sample, which is analyzed by Thin Layer Chromatography (TLC) on Silica Gel G plates (inorganic binder, #01011, 20 cm×20 cm, available from Analtech, Inc. Newark, DE). Three developing solvents were used in the TLC analysis: (1) 100% heptane; (2) toluene:hexane at a volume ratio of 160:40; and (3) hexane:diethyl ether:acetic acid at a volume ratio of 160:40:2; all solvents were purchased from Burdick & Jackson. The first solvent system is allowed to migrate up to the top of the TLC plate to the horizontal line (17.5 cm) and typically takes about 30 minutes. The TLC plate is dried for 20 minutes. The second solvent system is allowed to migrate 16.5 cm up the plate and typically takes about 26 minutes. The TLC plate is dried for 30 minutes. The third solvent system is allowed to migrate 9.5 cm up the plate and typically takes about 9 minutes. The TLC plate is dried for 30 minutes. Spray the dried TLC plate evenly with 5-7 milliliters of 25% sulfuric acid and place on a hot plate heated to 250°-260° C. and covered with a ceramic tape. Allow the plate to remain on the hot plate until fully charred (10-30 minutes). The charring time will vary according to the compounds tested. Remove the plate from the hot plate with heated spatulas (to prevent breakage) and place on a glass cloth pad to cool. The charred plated is scanned using Camag Scanner 3 densitometer (from Camag, Switzerland). A TLC spectrum was measured as area under the curve displayed by the densitometer. The total contaminants removed from the mixture was calculated using formula:

$$MR = S - ( \frac{A}{B} * S )$$

wherein MR=Mass of contaminants removed;
S=Mass of contaminants added to the mixture;
A=TLC area from a mixture containing an adsorbent material; and
B=TLC area from a mixture without adsorbent material.

Suitable particulate adsorbent materials may be activated carbons. It is generally believed that the large internal surface area and pore volume are characteristics responsible for the superior adsorption performance of activated carbons. A wide variety of activated carbons are commercially available, such as Adco® (available from Adco Inc. Sedalia, Mo.), KleenRite® (available from KleenRite Inc. St. Louis, Mo.) and CR1240A (available from Carbon Resources, Oceanside Calif.), all of which are currently used by commercial dry cleaning services. However, when these activated carbons are used in the cleaning system herein, they have been found to be unsatisfactory in removing contaminants from the used cleaning solvent. Specifically, these activated carbons used by commercial dry cleaning services have an Adsorption Capacity of less than about 160 mg contaminants per gram of adsorbent, which is far below the desired Adsorption Capacity to be considered useful in the cleaning system of the present invention. The following Table shows some of the properties exhibited by the activated carbons used by commercial dry cleaners:

| | Adsorption | | | |
|---|---|---|---|---|
| | Capacity (mg | | Average | Cumulative |
| | contaminants/ | Internal | Pore | Surface |
| Activated | gram | Surface Area | Diameter | Area |
| Carbons | adsorbent) | (m²/gram) | (Angstrom) | (m²/gram) |
| KleenRite ® | 36 | 612 | 68.3 | 363.7 |
| CR1240A | 136 | 1101 | 23.7 | 235.5 |
| Adco ® | 156 | 584 | 67.2 | 319.2 |

It is surprising to find that some activated carbons having a combination of large internal surface area or large cumulative surface area (cumulative in the range of 17 to 3000 Angstroms), and small average pore diameter exhibit exceptionally high adsorption capacity (typically greater than about 360 mg contaminants per gram of adsorbent), thus, are useful in the filtration device herein. It is more surprising to find that the cumulative pore volume (cumulative in the range of 17 to 3000 Angstroms) of these activated carbons generally are not very different from the cumulative pore volume of the activated carbons used by commercial cleaning services.

Preferred adsorbent materials useful in the filtration device described above are activated carbons having (i) an internal surface area at least about 1200 m²/gram, preferably from about 1200 to about 2000 m²/gram, and more preferably from about 1300 to about 1800 m²/gram; and (ii) an average pore diameter less than about 50 Angstroms, preferably ranging from about 20 to about 50 Angstroms and more preferably from about 30 about 40 Angstroms; and optionally (iii) a cumulative surface area at least about 400 m²/gram, preferably ranging from about 400 to about 2000 m²/gram, preferably from about 500 to about 1800 m2 /gram, and more preferably from about 600 to about 1600 m²/gram. Further, the activated carbons suitable for use herein have an Adsorption Capacity from about 200 to about 600 mg contaminants per gram of adsorbent, preferably from about 300 to about 550 mg contaminants per gram of adsorbent, and more preferably from about 400 to about 500 mg contaminants per gram of adsorbent.

Nonlimiting example of a suitable activated carbons include Acticarbone® BGX, available from Atofina Chemicals, Inc. Philadelphia, Pa.; Norit® GF-45 and Norit® C., available from Norit America, Inc. Atlanta, Ga. The following Table shows some of the properties exhibited by the activated carbons suitable for use herein:

| | Adsorption | | | |
|---|---|---|---|---|
| | Capacity (mg | Internal | Average | |
| | contaminants/ | Surface | Pore | Cumulative |
| Activated | gram | Area | Diameter | Surface Area |
| Carbons | adsorbent) | (m²/gram) | (Angstrom) | (m²/gram) |
| Acticarbone ® | 424 | 1661 | 37.4 | 1407.3 |
| BGX | | | | |
| Norit ® GF-45 | 464 | 1742 | 23.9 | 946.6 |
| Norit ® C | 384 | 1351 | 38.1 | 769.7 |

The internal surface area and cumulative surface area can be determined by the well known BET method that measures nitrogen adsorption at 77° K. The cumulative pore volume and average pore diameter can be determined by the BJH method that measures nitrogen adsorption at 77° K under BJH mesopore volume/size distribution. These methods are disclosed in more details by Brunauer et al., in J. Am. Chem. Soc., Vol. 60, 309 (1938); and Barrett et al. in J. Am. Chem. Soc., Vol. 73, 373 (1951). The BET and BJH measurements can be conducted with an Accelerated Surface Area and Porosity (ASAP) instrument, Model 2405, available from Micromeritics Instrument Corporation, Norcross, Ga.

The activated carbon may be fine powders having average particle sizes in the range of about 0.1-300 microns, preferably 0.1-200 microns. The average particle size can be measured by ISO 9001 EN-NS 45001 sieve anaylysis (using U.S. Standard Testing Sieves) or ASTM D4438-85.

The activated carbon may be modified by steam treatment, acid treatment and/or base treatment. In a preferred embodiment, the activated carbon is acid-treated activated carbon.

The activated carbon may be coconut shell-based, wood-based and/or coal-based. In a preferred embodiment, the activated carbon is wood-based.

Additional Adsorbent Materials

The adsorbent material useful in the present invention may further comprise one or more of the following adsorbent materials: a polar agent, an apolar agent, a charged agent, or mixtures thereof.

In a typical embodiment, the adsorbent material may comprise (a) charged agents and (b) polar and apolar agents that are commingled together. For example, the polar agents can be in the form of discrete particles and the apolar agents can be in the form of a fibrous structure, wherein the discrete particles of the polar agents are embedded, coated on, impregnated in, or bound to a fibrous substrate, such as a non-woven fibrous web.

a. Polar Agents

In one embodiment, a polar agent useful in the adsorbent material of the present invention has the formula:
(Yₐ—O_{b})X
wherein Y is Si, Al, Ti, P; a is an integer from about 1 to about 5; b is an integer from about 1 to about 10; and X is a metal.

In another embodiment, a polar agent suitable for use in the adsorbent material of the present invention is selected from the group consisting of: silica, diatomaceous earth, aluminosilicates, polyamide resin, alumina, zeolites and mixtures thereof. Preferably, the polar agent is silica, more specifically silica gel. Suitable polar agents include SILFAM® silica gel, available from Nippon Chemical Industries Co., Tokyo, Japan; and Davisil® 646 silica gel, available from W. R. Grace, Columbia, Md.

In yet another embodiment, a polar agent suitable for use in the adsorbent material of the present invention has an average particle size of from about 0.5 μm to about 500 μm.

In another embodiment, the polar agent is capable of regeneration such that the polar agent can release any contaminant that it temporarily removes from the used cleaning solvent upon being exposed to an environmental condition. An “environmental condition” as used herein means any physical or chemical condition that causes the polar agent to release the contaminant. Nonlimiting examples of environmental conditions include exposing the polar agent to a solvent, an acid, a base and/or a salt or their combination. The polar agents that are capable of regeneration typically exhibit a pKₐ or pK_{b} of from about 2 to about 8. Polar agents that are capable of regeneration can be reused for multi-cycle contaminant removal from cleaning solvents.

When present, the polar agent comprises from about 1% to about 99%, preferably from about 30% to about 70%, by weight of the adsorbent material.

b. Apolar Agents

Apolar agents suitable for use in the adsorbent material of the present invention comprise one or more of the following: polystyrene, polyethylene, and/or divinyl benzene. The apolar agent may be in the form of a fibrous structure, such as a woven or nonwoven web. Suitable apolar agents include Amberlite® XAD-16 and XAD-4, available from Rohm & Haas, Philadelphia, Pa.

When present, the apolar agent comprises from about 1% to about 99%, preferably from about 30% to about 70%, by weight of the adsorbent material.

Typically, when polar and apolar agents are present, the polar agents and apolar agents are present in the adsorbent material at a ratio of from about 1:10 to about 10:1, or from about 1:5 to about 5:1, or from about 1:2 to about 3:1.

c. Charged Agents

In one embodiment, the charged agent is selected from the group consisting of: anionic materials, cationic materials, zwitterionic materials and mixtures thereof.

In another embodiment, the charged agent has the formula:
(W−Z)T
wherein W is Si, Al, Ti, P, or a polymer backbone; Z is a charged substituent group and T is a counterion selected from alkaline, alkaline earth metals and mixtures thereof. For example, T may be: sodium, potassium, ammonium, alkylammonium derivatives, hydrogen ion; chloride, hydroxide, fluoride, iodide, carboxylate, etc. The W portion typically comprises from about 1% to about 15% by weight of the charged agent.

The polymer backbone typically comprises a material selected from the group consisting of: polystryrene, polyethylene, polydivinyl benzene, polyacrylic acid, polyacrylamide, polysaccharide, polyvinyl alcohol, copolymers of these and mixtures thereof.

The charged substituent typically comprises sulfonates, phosphates, quaternary ammonium salts and mixtures thereof. The charged substituent may comprise alcohols; diols; salts of carboxylates; salts of primary and secondary amines and mixtures thereof.

Suitable charged agents are available from Rohm & Haas, Philadelphi, Pa., under the designation IRC-50.

In another embodiment, the charged agent is capable of regeneration such that the charged agent can release any contaminant that it temporarily removes from the used cleaning solvent upon being exposed to an environmental condition. An “environmental condition” as used herein means any physical or chemical condition that causes the charged agent to release the contaminant. Nonlimiting examples of environmental conditions include exposing the charged agent to a solvent, an acid, a base and/or a salt or their combination. The charged agents that are capable of regeneration typically exhibit a pKₐ or pK_{b} of from about 2 to about 8. Charged agents that are capable of regeneration can be reused for multi-cycle contaminant removal from cleaning solvents.

When present, the charged agent comprises from about 1% to about 99%, preferably from about 30% to about 70%, by weight of the adsorbent material.

Absorbent Materials

a. Hydrogel-Forming Absorbent Polymers

The absorbent materials suitable for use in the present invention preferably comprise at least one hydrogel-forming absorbent polymer (also referred to as “absorbent gelling material” or “AGM”). Hydrogel-forming polymers useful in the present invention include a variety of water-insoluble, but water-swellable polymers capable of absorbing aqueous liquids.

Suitable absorbent gelling materials typically have a water absorbent capacity of at least about 50 grams of water, preferably at least about 80 grams of water, and more preferably at least about 100 grams of water, per gram of AGM. The water absorbent capacity test is disclosed in U.S. Pat. No. 5,741,581.

Hydrogel-forming absorbent polymers are also commonly referred to as “hydrocolloids” and can include polysaccharides such as carboxymethyl starch, carboxymethyl cellulose, and hydroxypropyl cellulose; nonionic types such as polyvinyl alcohol, and polyvinyl ethers; cationic types such as polyvinyl pyridine, polyvinyl morpholinione, and N,N-dimethylaminoethyl or N,N-diethylaminopropyl acrylates and methacrylates, and the respective quaternary salts thereof. Typically, hydrogel-forming absorbent polymers useful in the present invention have a multiplicity of anionic or cationic functional groups such as sulfonic acid or amide or amino groups, and more typically carboxy, groups. The carboxy groups in useful hydrogel-forming absorbent polymers may be introduced via copolymerization in the backbone or graft copolymerization. The copolymers may be partially neutralized, slightly network crosslinked, or both. These polymers can be used either solely or in the form of a mixture of two or more different polymers. Examples of these polymer materials are disclosed in U.S. Pat. Nos. 3,661,875; 4,076,663; 4,093,776; 4,666,983, and 4,734,478.

Other gelling materials are also suitable for use herein as the absorbent materials. Nonlimiting examples of these gels suitable for use herein may be based on acrylamides, acrylates, acrylonitriles, diallylammonium chloride, dialkylammonium chloride, and other monomers. Some suitable gels are disclosed in U.S. Pat. Nos. 4,555,344, 4,828,710, and European Application EP 648,521 A2.

In some embodiments, slightly network crosslinked polymers of partially neutralized polyacrylic acids and starch derivatives thereof are used as the hydrogel-forming absorbent polymers. The hydrogel-forming absorbent polymers comprise from about 50% to about 95%, preferably about 75%, neutralized, slightly network crosslinked, polyacrylic acid. Network crosslinking renders the polymer substantially water-insoluble and, in part, determines the absorptive capacity and extractable polymer content characteristics of the hydrogel-forming absorbent polymers. Processes for network crosslinking these polymers and typical network crosslinking agents are described in greater detail in U.S. Pat. No. 4,076,663.

The hydrogel-forming polymer component may also be in the form of a mixed-bed ion-exchange composition comprising a cation-exchange hydrogel-forming absorbent polymer and an anion-exchange hydrogel-forming absorbent polymer. Such mixed-bed ion-exchange compositions are described in, e.g., U.S. patent application Ser. No. 09/130,321, filed Jan. 7, 1998 by Ashraf, et al. (P&G Case 6976R); and U.S. Pat. No. 6,121,509.

The hydrogel-forming absorbent polymers can also comprise mixtures with low levels of one or more additives, such as surfactants, glue, binders, and the like. The components in this mixture can be physically and/or chemically associated in a form such that the hydrogel-forming polymer component and the non-hydrogel-forming additive are not readily physically separable.

Surface crosslinking is a preferred process for obtaining hydrogel-forming absorbent polymers having relatively high porosity hydrogel-layer (“PHL”), performance under pressure (“PUP”) capacity and saline flow conductivity (“SFC”) values, which may be beneficial in the context of the present invention. Suitable general methods for carrying out surface crosslinking of hydrogel-forming absorbent polymers according to the present invention are disclosed in U.S. Pat. No. 4,541,871 (Obayashi), issued Sep. 17, 1985; PCT application WO92/16565 (Stanley), published Oct. 1, 1992; PCT application WO90/08789 (Tai), published Aug. 9, 1990; PCT application WO93/05080 (Stanley), published Mar. 18, 1993; U.S. Pat. No. 4,824,901 (Alexander), issued Apr. 25, 1989; U.S. Pat. No. 4,789,861 (Johnson), issued Jan. 17, 1989; U.S. Pat. No. 4,587,308 (Makita), issued May 6, 1986; U.S. Pat. No. 4,734,478 (Tsubakimoto), issued Mar. 29, 1988; U.S. Pat. No. 5,164,459 (Kimura et al.), issued Nov. 17, 1992; German patent application 4,020,780 (Dahmen), published Aug. 29, 1991; European patent application 509,708 (Gartner), published Oct. 21, 1992; U.S. Pat. No. 5,562,646 (Goldman et al.), issued Oct. 8, 1996; and U.S. Pat. No. 5,599,335 (Goldman et al.), issued Feb. 4, 1997.

For some embodiments of the present invention, it is advantageous if the hydrogel-forming absorbent polymers are in the form of particles and are typically substantially dry. The term “substantially dry” is used herein to mean that the particles have a natural liquid content, typically water or other liquid content, less than about 40%, preferably less than about 20%, and more preferably less than 10% by weight of the particles. In general, the natural liquid content of the hydrogel-forming absorbent polymer particles is in the range of from about 0.01% to about 5% by weight of the particles. These particles may be dried (i.e., to release absorbed water and/or other liquids) by conventional methods such as heating, or by contacting a dewatering solvent such as methanol, or combinations of these methods.

b. High Surface Area Materials

In addition to the osmotic absorbents (for example, hydrogel-forming absorbent polymers disclosed above), the present invention may also comprise capillary sorption materials, such as a high surface area material. It is recognized that high surface area materials provide one or both of the following functions: i) a capillary pathway of liquid to enter and permeate the osmotic absorbents, and ii) additional absorbent capacity, via capillary action, of the osmotic absorbents. Thus, high surface area materials generally provide the suction capability within the separation apparatus or vessel used in the present invention, leading to an improved overall absorbency (i.e., higher absorbent capacity and quicker liquid uptake).

In one embodiment, the high surface area materials are “high surface area fibers”, which form a fibrous web or a fibrous matrix. In another embodiment, the high surface area material comprises an open-celled, hydrophilic polymeric foam.

High surface area fibers useful in the present invention include those that are naturally occurring (modified or unmodified), as well as synthetic fibers. The high surface area fibers have surface areas much greater than fibers typically used in absorbent articles, such as wood pulp fibers. High surface area fibers useful herein include glass microfibers such as, for example, glass wool available from Evanite Fiber Corp. (Corvallis, Oreg.). Another type of high surface area fibers useful herein are fibrillated cellulose acetate fibers. (referred to herein as “fibrets”) have high surface areas relative to cellulose-derived fibers commonly employed in the absorbent article art. Representative fibrets useful as the high surface area materials herein are available from Hoechst Celanese Corp. (Charlotte, N.C.) as cellulose acetate Fibrets®. For a detailed discussion of fibrets, including their physical properties and methods for their preparation, see “Cellulose Acetate Fibrets: A Fibrillated Pulp With High Surface Area”, Smith, J. E., Tappi Journal, December 1988, p. 237; and U.S. Pat. No. 5,486,410 (Groeger et al.) issued Jan. 23, 1996.

In addition to these fibers, the skilled artisan will recognize that other fibers well known in the absorbency art may be modified to provide high surface area fibers for use herein. Representative fibers that may be modified to achieve high surface areas required by the present invention are disclosed in U.S. Pat. No. 5,599,335.

c. Spacers

The spacer materials suitable for use in the present invention include any fibrous or particulate material that is, at most, only slightly soluble in water and/or cleaning solvent. The spacer can be dispersed throughout a matrix of absorbent material in order to improve its permeability above that of a matrix made up of an absorbent material alone; or, the spacer can be used to maintain permeability even after the absorbent material swells and /or gels upon exposure to water. Therefore, the spacer helps reduce the pressure drop across an absorbent material matrix when a water-bearing fluid is passed through the matrix. In addition, if the absorbent material is prone to congealing after exposure to water and subsequent collapse, the spacer can aid in the reduction or prevention of gel congealing and collapse.

Non-limiting examples of suitable spacer materials include sand, silica, aluminosilicates, glass microspheres, clay, layered silicates, wood, natural textile materials, synthetic textile materials, alumina, aluminum oxide, aluminum silicate, zinc oxide, molecular sieves, zeolites, activated carbon, diatomaceous earth, hydrated silica, mica, microcrystalline cellulose, montmorillonite, peach pit powder, pecan shell powder, talc, tin oxide, titanium dioxide, walnut shell powder, and particles of different metals or metal alloys. Also useful are particles made from mixed polymers (e.g., copolymers, terpolymers, etc.), such as polyethylene/polypropylene copolymer, polyethylene/propylene/isobutylene copolymer, polyethylene/styrene copolymer, and the like. Some of these spacer materials may already present in the filtration device to provide the adsorbent or absorbent capacities of the device, thus, additional spacer materials are merely optional.

Other particulate materials useful herein are the synthetic polymeric particles selected from the group consisting of polybutylene, polyethylene, polyisobutylene, polymethylstyrene, polypropylene, polystyrene, polyurethane, nylon, teflon, and mixtures thereof. Of these, the most preferred are polyethylene and polypropylene particles, with the oxidized versions of these materials being especially preferred. Examples of commercially available particles useful herein include the Acumist® micronized polyethylene waxes available from Allied Signal (Morristown, N.J.) available as the A, B, C, and D series in a variety of average particle sizes ranging from 5 microns to 60 microns. Preferred are the Acumist® A-25, A-30, and A-45 oxidized polyethylene particles having a means particle size of 25, 30, and 45 microns, respectively. Examples of commercially available polypropylene particles include the Propyltex® series available from Micro Powders, Inc. (Terrytown, N.Y.) and Acuscrub® 51, available from Allied Signal (Morristown, N.J.) having a mean particle size of about 125 microns.

d. Absorbent Matrix

In order to increase the absorbent matrix permeability when it is dry and/or maintain the permeability of the absorbent matrix when it is wet, it is important to provide an sufficient ratio between the absorbent materials and spacers, and, optionally, high surface area materials. Since the weight of the absorbent materials can vary greatly between its dry and wet state, the ratio between the spacers and the absorbent materials is quantified on a “dry” volumetric basis.

As used herein, the term “dry bulk matrix volume” is the sum of the net matrix volume and the intra-material void volume, on a dry basis. As used herein, the term “net matrix volume” is the volume physically occupied by the absorbent materials, the spacers, and the optional high surface area materials, excluding any inter-material voids or intra-material voids. As used herein, the term “intra-material void volume” is the cumulative volume of voids within material particles and/or fibers that typically and naturally occurs when particles and/or fibers occupy a given space. The dry bulk matrix volume can be determined from ASTMC559-90 (2000) bulk density measurement by dividing desired mass of a material by its bulk density. In a typical embodiment of the present invention, from about 50 to about 100 vol %, more preferably from about 75 to about 95 vol %, of the dry bulk matrix volume, is the absorbent material; from about 1 to about 50 vol %, more preferably from about 5 to about 25 vol %, of the dry bulk matrix volume, is the spacer; and optionally, from about 1 to about 50 vol %, more preferably from about 5 to about 25 vol %, of the dry bulk matrix volume, is the high surface area material.

Contaminants

The contaminants that may enter the cleaning solvent during fabric treating processes typically include: surfactants, water, dyes, soils and other non-cleaning solvent materials, including auxiliary cleaning agents and other cleaning adjuncts.

a. Water

A major contaminant present in the system of the present invention is water. Surfactant-containing cleaning solvent is especially prone to form a water/solvent emulsion in the cleaning process.

Water may be present in the used cleaning solvent at any level. Typically, water is present in the used cleaning solvent at a level of from about 0.001% to about 10%, more preferably from about 0.005% to about 5%, even more preferably from about 0.01% to about 1%, by weight of the used cleaning solvent.

The source of the water may vary. Water may be added during the fabric treating process to enhance the cleaning effect, or water may be present in the cleaning composition. In some embodiments, water comprises from about 0% to about 5% or from about 0% to about 3% or from about 0.0001% to about 1%, by weight of the cleaning composition.

b. Surfactants

Surfactants and surfactant-type materials, which have properties similar to surfactants, may be present in the used cleaning solvent of the present invention. These contaminants may become mixed with the cleaning solvent as a result of a fabric treating process, wherein surfactants and surfactant-type materials may have been extracted from the fabric being treated, or may have been present in the cleaning composition as adjunct ingredients.

A wide range of conventional surfactants can be used as treating agents in the cleaning compositions of the present invention. The surfactant can be nonionic, anionic, amphoteric, amphophilic, zwitterionic, cationic, semi-polar nonionic, and mixtures thereof. Nonlimiting examples of which are disclosed in U.S. Pat. Nos. 3,664,961, 5,707,950 and 5,576,282.

Some examples of the surfactants commonly used in a cleaning composition include the following: anionic surfactants such as alkyl or aryl sulfates, aerosol derivatives, etc.; cationic or basic surfactants such as quaternary surfactants, primary and secondary amines, etc.; and non-ionic surfactants such as Brij® surfactants, Neodol® surfactants, etc.

Surfactants may comprise from about 0.01% to about 80%, preferably from about 0.01% to about 60%, and more preferably from about 1% to about 50%, by weight of the cleaning composition

The surfactant-type material is a material that is capable of suspending water in a cleaning solvent and enhancing soil removal benefits of a cleaning solvent. These materials are soluble in the cleaning solvent in order to perform the above functions satisfactorily. As used herein, the term “capable of suspending water in a cleaning solvent” means that a material is able to suspend, solvate or emulsify water, which is immiscible with the cleaning solvent, in a way that the water remains visibly suspended, solvated or emulsified when left undisturbed for a period of at least five minutes after initial mixing of the components. In some examples, the mixtures may be colloidal in nature and/or appear milky. In other examples, the mixtures may be transparent.

The surfactant-type material may be siloxane-based surfactants, such as polyether siloxans. Nonlimiting examples of this type of siloxane-based surfactants are described in EP 1,043,443A1, EP1,041,189 and WO 01/34,706 (all to GE Silicones); and EP 1,092,803A1, U.S. Pat. Nos. 5,676,705; 5,683,977; and 5,683,473 (all to Lever Brothers). Suitable commercial siloxane materials include TSF 4446 and XS69-B5476 (both available from General Electric Silicones); Jenamine HSX (available from DelCon, Pennington, N.J. and Y12147 (available from OSi Specialties, Berkshire, UK).

Other suitable surfactant-type materials are organic in nature, such as organosulfosuccinate surfactants, with carbon chains of from about 6 to about 20 carbon atoms. This type of organic surfactants are soluble in the cleaning solvent used in the present invention. Nonlimiting commercially available examples of suitable organosulfosuccinate surfactants are available under the trade names of Aerosol® OT and Aerosol® TR-70 (available from Cytec, Carmel, Ind.).

Other suitable surfactant-type materials include non-silicone additives. The non-silicone additives preferably comprise a strongly polar and/or hydrogen-bonding head group. Examples of the strongly polar and/or hydrogen-bonding head group are alcohols, carboxylic acids, sulfates, sulphonates, phosphates, phosphonates, and nitrogen containing materials. Preferred non-silicone additives are nitrogen containing materials selected from the group consisting of primary, secondary and tertiary amines, diamines, triamines, ethoxylated amines, amine oxides, amides, betaines, quaternary ammonium salts, and mixtures thereof. Alkylamines are particularly preferred. Even more preferred are primary alkylamines comprising from about 6 to about 22 carbon atoms.

Nonlimiting commercially available examples of suitable alkylamines are oleylamine (available from Akzo under the tradename Armeen® OLD), dodecylamine (available from Akzo under the tradename Armeen® 12D), branched C₁₆-C₂₂ alkylamine (available from Rohm & Haas under the tradename Primene® JM-T), and mixtures thereof.

The surfactant-type material, when present in the used cleaning solvent may be present at at any level, and is typically a level of from about 0.01% to about 10%, more preferably from about 0.02% to about 5%, even more preferably from about 0.05% to about 2% by weight of the used cleaning solvent.

c. Auxiliary Cleaning Agents

In one embodiment, the auxiliary cleaning agent is insoluble in water. In another embodiment, the auxiliary cleaning agent is insoluble in water, but soluble in a cleaning solvent. In yet another embodiment, the auxiliary cleaning agent is insoluble in water, soluble in a cleaning solvent and has an HLB of from about 1 to about 9 or from about 1 to about 7 or from about 1 to about 5. In a further embodiment, the auxiliary cleaning agent in conjunction with a solubilizing agent is at least partially soluble in a cleaning solvent and/or water. When present, the auxiliary cleaning agent is at a level in the treating composition at from about 0.001% to about 5% or from about 0.001% to about 3% or from about 0.001% to about 1% by weight of the treating composition; and the solubilizing agent is at a level of about 0.1 % to about 5% by weight of the auxiliary cleaning agent.

Nonlimiting examples of suitable auxiliary cleaning agents include treating agents commercially available from Dow Corning under trade designations such as DC1248, SF1528 DC5225C and DCQ4 3667; and Silwets® from Witco under trade designations such as L8620, L7210, L7220.

The Cleaning System

FIG. 1 shows an embodiment of the present invention with a two stage filtration. The first stage filtration removes primarily dyes and/or other adjuncts during a washing cycle without removing surfactants; and the second stage filtration substantially removes all the contaminants present in the used solvent.

In the first stage, working solvent in reservoir 10 is delivered via conduit 20 to treating vessel 30 (e.g., a wash basket in a conventional washing machine). During a washing cycle, a working solvent is re-circulated through a in-wash prefilter 70 by directing flow through conduit 40, 3-way valve 50, and conduit 60. After passing the solvent through in-wash prefilter 70, the solvent is returned into vessel 30 via conduit 80. Optionally, a second prefilter (not shown) may be positioned along conduit 90 and/or conduit 105 to further facilitate the removal of contaminants. The prefilter(s) may contain activated carbons, other adsorbent materials, and/or particulate-sieve materials.

In the second stage, the used solvent is typically collected in used solvent reservoir 100 after the washing cycle. Then, the used solvent is passed through conduit 105 into a dual filter 110 having two compartments 113, 115. After passing through compartments 113, 115, the filtered solvent is returned to working solvent reservoir 10 via conduit 120. The sequence of passing the used solvent through compartments 113 and 115 can be reversed. In one embodiment, compartment 113 contains an adsorbent material, such as an acid-treated activated carbon and compartment 115 contains an absorbent material such as cross-linked sodium polyacrylate polymer gel with particle size from about 50 to about 1000 microns. In another embodiment, at least one of the compartments 113, 115 contains a mixture of adsorbent/absorbent materials.

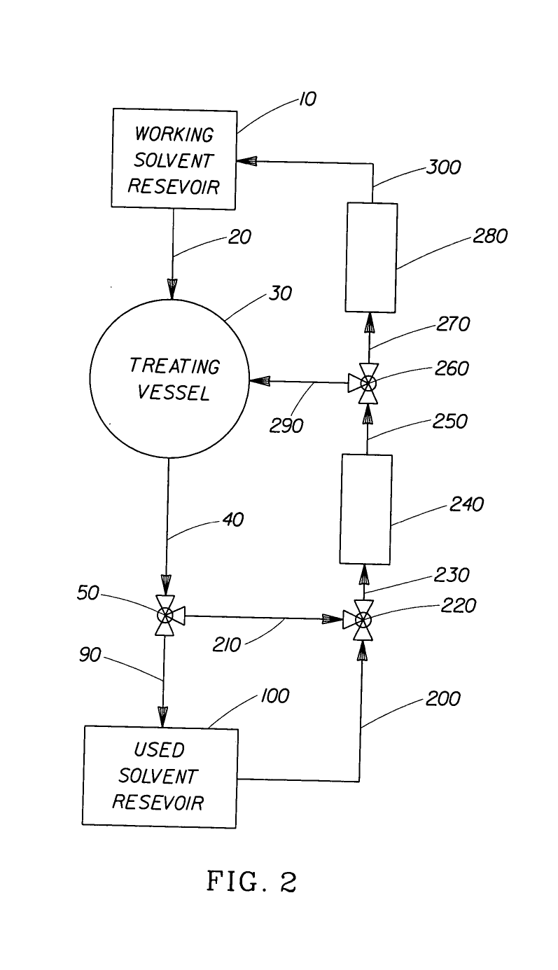

FIG. 2 shows another embodiment of the present invention. In the first stage, working solvent in reservoir 10 is delivered via conduit 20 to treating vessel 30. During a wash cycle, the cleaning solvent is re-circulated through a prefilter 240 by directing flow through conduit 40, 3-way valve 50, conduit 210, three-way valve 220, and conduit 230 into the prefilter 240. After passing the cleaning solvent through prefilter 240, the cleaning solvent is returned into vessel 30 via three-way valve 260 and conduit 290. Prefilter 240 contains an adsorbent material.

In the second stage, the used solvent is collected in used solvent reservoir 100 after the washing cycle. Then, the used solvent is passed into prefilter 240 and decontamination filter 280 via conduit 200, three way valve 220, conduit 230, conduit 250, three way valve 260, and conduit 270. The decontamination filter 280 may contain an absorbent material, an adsorbent material, or mixtures thereof. In another embodiment, the decontamination filter 280 can be a dual filter, such as filter 110 of FIG. 1. In configurations that contain multiple adsorbent-containing filters, the capacity as well as lifetime of the filtration device is increased, due to the increased amount of adsorbent materials.

In yet another embodiment (not shown), the filtration system may contain only one solvent reservoir 100. In such embodiment, solvent reservoir 10 is omitted and conduit 120 of FIG. 1 and conduit 300 of FIG. 2 are connected directly to solvent reservoir 100, and additional conduits connect solvent reservoir 100 to vessel 30 to feed the solvent to treating vessel 30 at the beginning of the washing cycle. This arrangement simplifies the system and eliminates the need for an additional solvent reservoir.

In still another embodiment, filtration system may contain only one reservoir 100 shown in FIG. 1. In such embodiment, working solvent reservoir 10, filter 110, and conduits 105 and 120 are omitted. In such embodiment, adsorbent and/or absorbent materials are added directly into reservoir 100 in a form of pouch, where reservoir 100 is provided with means of agitation and/or mixing of added materials. This arrangement simplifies the system and makes efficient use of the adsorbent and/or absorbent materials. The single reservoir systems described here and above are preferred for in-home appliances where the available space may be limited.

The described systems configuration may vary. However, it's preferred that during washing cycle, used solvent does not come in contact with stage two filtration filters as it would reduce the filters lifetime (time to reach contaminant holding capacity) and may have negative impact on cleaning, since the second stage filters may remove significant amount of some components of the cleaning composition. It is also preferred, that during the washing cycle, the first stage filtration filter contains no water absorbent materials, since water can function as an auxiliary cleaning agent for removing hydrophilic soils from the fabric article.

The residence time in each stage of the filtration should be sufficient to remove the desired type and/or level of contaminants from the solvent. Factors contributing to the removal of contaminants (e.g., size or path length of the filter/compartment, amount of adsorbent/absorbent materials) can be adjusted to achieve the suitable residence time.

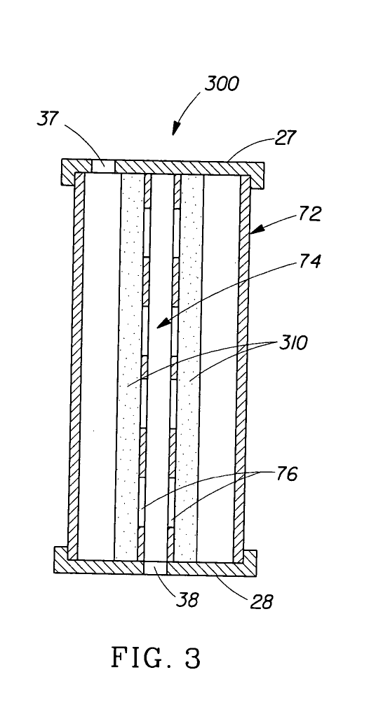

An embodiment of a filter 300 is shown in FIG. 3. Filter 300 contains an outer cylinder 72 sealed from both ends by discs 27 and 28. The disc 27 has an inlet opening 37 that provide access to the inside of the outer cylinder 72. The disc 28 has an outlet opening 38 that provide access to the inside of the inner cylinder 74. Filtration media 310 forms a barrier between the inside of outer cylinder 72 and inner cylinder 74. The filtration media 310 comprises a fibrous material used to support the particulate adsorbent material, the superabsorbent polymer particles, or mixtures thereof. The particles are uniformly distributed through the fibrous material. When in operation, the used solvent is pumped through inlet 37 to the inside the outer cylinder 72, where it comes into contact with filtration media 310. Then, the solvent flows through the openings/perforations 76 on the surface of inner cylinder 74 to the inside of inner cylinder 74 and out of filter 300 through outlet 38.

Fibrous material may be used to provide a support structure for the adsorbent/absorbent particles and to provide sufficient void space between particles. The void space allows the particles (specifically, the absorbent polymer gel particles) to swell upon exposure to water without restricting the flow of the solvent through the filter.

The cleaning system of the present invention may comprise a contaminant sensor (not shown) that measures the level of contaminants within the system, specifically within the used cleaning solvent. Such contaminant sensors may be positioned within the system such that the used cleaning solvent contacts the contaminant sensor before and/or after contacting the filters. Multiple contaminant sensors may be used, depending upon the contaminants to be detected. Suitable contaminant sensors for detecting specific contaminants are known to those of ordinary skill in the art. A preferred use of contaminant sensor is when sensor is placed after the first and/or the second filtration stage to indicate contaminants concentration in solvent after passing used cleaning solvent thru a filtration stage. When contaminants concentration exceeds some pre-determined value, it would indicate that a filter has reached maximum contaminant holding capacity and needs to be changed.

In a preferred embodiment, the absorbent material may comprise surface cross-linked polymer, such as surface cross-linked polyacrylate, surface cross-linked polyacrylamide, or combinations of these absorbent materials. Further, any of the absorbent materials may have a fibrous morphology, a particulate morphology, or mixtures of any of the absorbent materials with similar or different morphologies. The absorbent material may take several forms, including but not limited to, a porous woven sheet impregnated with absorbent materials, a film, or a membrane.

In order to aid the absorption of water from and/or separation of the cleaning solvent and water emulsion, it may be desirable to increase the temperature of the emulsion (by at least about 10° C.) prior to exposing the emulsion to the absorbent material. However, the temperature of the cleaning solvent and water emulsion is preferably kept at no higher than about 50° C. prior to exposing the emulsion to absorbent material. This is so because some absorbent materials cannot absorb water at higher temperatures, particularly when high temperature is one of their trigger or collapse mechanisms (i.e., de-watering mechanisms). Alternatively, it may be desirable to cool the emulsion, and/or add demulsifying agents to the emulsion in order to aid the absorption of water from and/or separation of the cleaning solvent and water emulsion.

Once the absorbent material has absorbed at least a portion of the water from the emulsion, it is desirable to trigger the absorbent material to release the removed water by exposing the absorbent material to a trigger mechanism, including, but not limited to, light, pH, temperature, sound, electric field, pressure, ionic strength, vibration, and combinations thereof. Absorbent material “trigger” or “collapse” mechanisms and methods for their introduction are well known in the absorbent material arts.

Once water is separated from the emulsion by an absorbent material, the separated cleaning solvent may be exposed to activated carbon in order to further facilitate its purification and recycling into the system. Further, the removed water may also be exposed to activated carbon prior to its disposal or recycling into the system. Methods to purify the separated cleaning solvent include well-known distillation methods, membrane filters, adsorption methods, absorption methods, extraction methods, ion exchange methods, air stripping methods, and chromatography.

The used cleaning solvent or cleaning composition may also contain up to about 10% emulsifier (which typically comprises a surfactant) by weight of the emulsion. If it does contain emulsifier, it is preferable for the used cleaning solvent or cleaning composition to have a water/cleaning solvent/emulsifier ratio of from about 1/98.9/0.1 to about 40/55/5 by weight of the emulsion.

It was also discovered that polymer gels, especially the ionic type, provide an additional benefit of removing surfactants from the cleaning solvent/water emulsion. In operation, contacting cleaning solvent/water emulsion with ionic gels results in an increase of dry weight (i.e., after triggering or collapsing the gel to release water) of ionic gels. The increase in dry weight of gels corresponded to a significant amount of surfactants being absorbed into the ionic gel structure. It is worth noting that, even though significant amount of surfactant is absorbed into the gel, the water absorbing capacity of the gel remains the same. The surfactants that are removed may include the following nonlimiting examples: anionic surfactants (e.g., alkyl or aryl sulfates, aerosol derivatives, etc); cationic or basic surfactants (e.g., quaternary surfactants, primary and secondary amines, etc.); and combinations of above.

The cleaning composition may contain adjunct ingredients selected from the group consisting of enzymes, bleaches, surfactants, fabric softeners, perfumes, antibacterial agents, antistatic agents, brighteners, dye fixatives, dye abrasion inhibitors, anti-crocking agents, wrinkle reduction agents, wrinkle resistance agents, soil release polymers, sunscreen agents, anti-fade agents, builders, sudsing agents, composition malodor control agents, composition coloring agents, pH buffers, waterproofing agents, soil repellency agents, and mixtures thereof. Such adjunct ingredients may be present in the cleaning composition from about 0.01 to about 10% by weight of the cleaning composition.

In some embodiments of the present invention, the cleaning solvent comprises a linear siloxane, a cyclic siloxane, and mixtures of these siloxanes. These siloxanes can be selected from the group consisting of octamethylcyclotetrasiloxane, decamethylcyclopentasiloxane, dodecamethylcyclohexasiloxane, and mixtures of these siloxanes. In one embodiment, the cleaning solvent comprises decamethylcyclopentasiloxane. In another embodiment, the cleaning solvent comprises decamethylcyclopentasiloxane and is substantially free of octamethylcyclotetrasiloxan

Method

The present invention is directed to a method for removing contaminants from a used, contaminated cleaning solvent or cleaning composition, which may comprise an emulsion of a cleaning solvent and water. The method includes exposing the used, contaminated cleaning solvent or cleaning composition to a filter to remove water and/or other contaminants from the cleaning solvent or cleaning composition. The methods include conventional immersive cleaning methods as well as the non-immersive cleaning methods disclosed in U.S. Patent Applications US20020133886A1 and US20020133885A1.

The method may also include the initial steps of exposing a fabric article to a working cleaning solvent or a cleaning composition comprising cleaning solvent and other cleaning adjuncts such as water or surfactants; alternatively, water may be applied from a separate source to the fabric in this initial step; then, recovering the used, contaminated cleaning solvent or cleaning composition, typically in the form of the cleaning solvent and water emulsion. The cleaning solvent thus recovered may be reused as the working cleaning solvent or be reformulated into a recycled cleaning composition, both of which can be applied to the fabric in another cleaning cycle.

The removal of water from the used cleaning solvent or cleaning composition can be accomplished by passing it through an adsorbent material as described above. Additionally, the used cleaning solvent or cleaning composition may pass through a particulate-sieve filter to remove particles and particle aggregates about 25 microns or larger, preferably about 10 microns or larger, more preferably about 5 microns or larger are removed, even more preferably about 1 micron or larger.

Apparatus

The present invention also includes an apparatus suitable for use in the method described above and embodied in FIGS. 1 and 2.

The methods and systems of the present invention may be used in a service, such as a cleaning service, diaper service, uniform cleaning service, or commercial business, such as a Laundromat, dry cleaner, linen service which is part of a hotel, restaurant, convention center, airport, cruise ship, port facility, casino, or may be used in the home.

The methods of the present invention may be performed in an apparatus that is a modified existing apparatus and is retrofitted in such a manner as to conduct the method of the present invention in addition to related methods.

The methods of the present invention may also be performed in an apparatus that is specifically built for conducting the present invention and related methods.

Further, the methods of the present invention may be added to another apparatus as part of a cleaning solvent processing system. This would include all the associated plumbing, such as connection to a chemical and water supply, and sewerage for waste wash fluids.

The methods of the present invention may also be performed in an apparatus capable of “dual mode” functions. A “dual mode” apparatus is one capable of both washing and drying fabrics within the same vessel (i.e., drum). These apparatuses are commercially available, particularly in Europe.

An apparatus suitable for use in the present invention will typically contain some type of control systems, including electrical systems, such as “smart control systems”, as well as more traditional electromechanical systems. The control systems would enable the user to select the size of the fabric load to be cleaned, the type of soiling, the extent of the soiling, the time for the cleaning cycle. Alternatively, the control systems provide for pre-set cleaning and/or refreshing cycles, or for controlling the length of the cycle, based on any number of ascertainable parameters the user programed into the apparatus. For example, when the collection rate of cleaning solvent reaches a steady rate, the apparatus could turn its self off after a fixed period of time, or initiate another cycle for the cleaning solvent.

In the case of electrical control systems, one option is to make the control device a so-called “smart device”, which provides smart functions, such as self diagnostics; load type and cycle selection; Internet links, which allow the user to start the apparatus remotely, inform the user when the apparatus has cleaned a fabric article, or allow the supplier to remotely diagnose problems if the apparatus malfunctioned. Furthermore, if the system of the present invention is only a part of a cleaning system, the so called “smart system” could be communicating with the other cleaning devices which would be used to complete the remainder of the cleaning, such as a washing machine, and a dryer.

All documents cited are, in relevant part, incorporated herein by reference; the citation of any document is not to be construed as an admission that it is prior art with respect to the present invention.

While particular embodiments of the present invention have been illustrated and described, it would be apparent to those skilled in the art that various other changes and modifications can be made without departing from the spirit and scope of the invention. It is therefore intended to cover in the appended claims all such changes and modifications that are within the scope of this invention.

What is claimed is:

1. A system for non-aqueous cleaning of a fabric article comprising:
(a) a reservoir of a working solvent;
(b) a fabric article treating vessel operatively connected to the reservoir, wherein the working solvent comes into contact with a fabric article in the vessel and removes contaminants from the fabric article, thereby converting the working solvent into a used solvent in the form of an emulsion comprising a siloxane solvent, water, and optionally, a surfactant; and
(c) a filtration device for removing contaminants from the used solvent thereby converting the used solvent to a filtered solvent comprising up to 20% by weight of the filtered solvent of water, wherein the filtration device is operatively connected to the reservoir and/or the vessel and comes into contact with the used solvent during the operation of the system;
wherein the filtration device comprises an absorbent material having a water absorbing capacity of at least about 50 g of water/g of absorbent material and an adsorbent material having an adsorbent capacity at least about 200 mg contaminants per gram of adsorbent material.

2. The system according to claim 1 wherein the adsorbent material is an activated carbon having
(i) an internal surface area of at least about 1200 m²/g;
(ii) an average pore diameter less than about 50 Angstroms; and
(iii) optionally, a cumulative surface area of at least about 400 m²/g.

3. The system according to claim 2 wherein the activated carbon has one or more of the following properties:
(i) an internal surface area ranging from about 1200 m²/g to about 2000 m²/g;
(ii) an average pore diameter ranging from about 20 to about 50 Angstroms;
(iii) an adsorbent capacity of from about 200 to about 600 mg contaminants per grams of adsorbent material;
(iv) a cumulative surface area ranging from about 400 m²/g to about 2000 m²/g; and
(v) an average particle size ranging from about 0.1 to about 300 microns.

4. The system according to claim 2 wherein the adsorbent material is an acid treated activated carbon.

5. The system according to claim 4 wherein the adsorbent material comprises a wood-based activated carbon.

6. The system according to claim 1 wherein the adsorbent material further comprises an additional adsorbent material selected from the group consisting of a polar agent, a nonpolar agent, a charged agent, and mixtures thereof.

7. The system according to claim 1 wherein the used solvent has a water/siloxane solvent weight ratio of about 1:98.9 to about 40:55.

8. The system according to claim 1 wherein the used solvent further comprises a contaminant selected from the group consisting of dyes, soils, and mixtures thereof.

9. The system according to claim 1 wherein the absorbent material comprises an absorbent gelling material (AGM).

10. The system according to claim 1 wherein the used solvent contacts the adsorbent material and the absorbent material separately or simultaneously.

11. The system according to claim 1 wherein the absorbent material and the adsorbent material are contained in a single housing or separate, discrete housings.

12. The system according to claim 1 further comprising a contaminant sensor connected to the filtration device on one end, or connected to both the filtration device and the vessel on opposite ends.

13. The system according to claim 1 wherein the working solvent comprises a siloxane solvent, and optionally comprises a lipophilic fluid selected from the group consisting of a hydrocarbon solvent, a glycol ether solvent, a fluorinated solvent, a perfluorinated amine, a diol solvent, a perchloroethylene (PERC) solvent, and mixtures thereof.

14. A method for treating a fabric article and removing contaminants from the solvent comprising the steps of:
a. contacting a fabric article with a working solvent to remove contaminants from the fabric article, thereby converting the working solvent into a used solvent in the form of an emulsion comprising a siloxane solvent, water, and optionally, a surfactant;
b. removing the used solvent from the fabric article;
c. contacting the used solvent with a filtration device, thereby converting the used solvent into a filtered solvent comprising up to 20% by weight of the filtered solvent of water; and
d. optionally, using the filtered solvent as the working solvent in step (a);
wherein the filtration device comprises an absorbent material having a water absorbing capacity of at least about 50 g of water/g of absorbent material and an adsorbent material having an adsorbent capacity at least about 200 mg contaminants per gram of adsorbent material.

15. The method according to claim 14 wherein the adsorbent material is dispersed in the used solvent or is contained in a housing in step (c).

16. The method according to claim 14 wherein the adsorbent material is an activated carbon having
(i) an internal surface area of at least about 1200 m²/g;
(ii) an average pore diameter less than about 50 Angstroms; and
(iii) optionally, a cumulative surface area of at least about 400 m²/g.

17. The method according to claim 14 wherein the activated carbon has one or more of the following properties:
(i) an internal surface area ranging from about 1200 m²/g to about 2000 m²/g;
(ii) an average pore diameter ranging from about 20 to about 50 Angstroms;
(iii) an adsorbent capacity of from about 200 to about 600 mg contaminants per grams of adsorbent material;
(iv) a cumulative surface area ranging from about 400 m²/g to about 2000 m²/g; and
(v) an average particle size ranging from about 0.1 to about 300 microns.

18. The method according to claim 14 wherein the adsorbent material is acid treated activated carbon.

19. The method according to claim 14 wherein the used solvent has a water/siloxane solvent weight ratio of about 1:98.9 to about 40:55.

20. The method according to claim 14 wherein the used solvent further comprises a contaminant selected from the group consisting of dyes, soils, and mixtures thereof.

21. The system according to claim 14 wherein the working solvent comprises a siloxane solvent, and optionally comprises a lipophilic fluid selected from the group consisting of a siloxane solvent, a hydrocarbon solvent, a glycol ether solvent, a fluorinated solvent, a perfluorinated amine, a diol solvent, a perchloroethylene (PERC) solvent, and mixtures thereof.

22. The method according to claim 14 wherein the siloxane solvent is selected from the group consisting of octamethylcyclotetrasiloxane, decamethylcyclopentasiloxane, dodecamethylcyclohexasiloxane, and mixtures thereof.
